(19) United States
(12) Patent Application Publication
(10) Pub. No.: US 2010/0243712 A1
(43) Pub. Date: Sep. 30, 2010

(54) THERMODE, CLAMPING ARRANGMENT THEREFOR, AND METHOD OF MANUFACTURE

(75) Inventors: Gerry WOOTTON, Cambridge (CA); Joel Dunlop, Cambridge (CA); Darko Maldini, Cambridge (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: ATS Automation Tooling Systems Inc., Cambridge (CA)

(21) Appl. No.: 12/749,310

(22) Filed: Mar. 29, 2010

Related U.S. Application Data
(60) Provisional application No. 61/164,163, filed on Mar. 27, 2009.
(60) Provisional application No. 61/222,523, filed on Jul. 2, 2009.

(51) Int. Cl. B23K 3/02; B32B 38/04

(52) U.S. Cl. 228/51; 156/256

(57) ABSTRACT

A thermode comprising: a shank; a tip; and a transition zone between the shank and the tip, the transition zone configured to provide resistance gradients to improve containment of heat in the tip. The thermode may also include an integrated cooling jet. The shank, tip, transition zone and integrated cooling jet may all be formed from a single workpiece. The thermode may also be formed with a compact mount that is integrated with the shank and that can be combined with a clamping arrangement to provide efficient replacement of the thermode from the clamping arrangement.

### PRIORITY

This patent application claims the benefit of U.S. Patent Applications 61/164,163, filed Mar. 27, 2009, and 61/222,523, filed Jul. 2, 2009, which are hereby incorporated herein by reference.

### FIELD

The present application relates generally to an apparatus and components used in the application of heat. More particularly, the present application relates to a thermode and methods of assembling and manufacturing a thermode.

### BACKGROUND

Thermodes are devices used for local application of heat, typically in soldering and heat staking applications and the like. Heat is produced by direct resistance heating of the tip of the thermode. The ‘soldering gun’ is a common example.

The main advantage of thermodes is very rapid temperature change (can be >1000° C./sec) and generally with precise control over the temperature. Also, since the resistance element is typically in direct contact with an item to be heated, efficient heat transfer occurs and rapid heating of the item is possible. Since the tip has little thermal mass, rapid cooling to ambient is typically also possible. Forced air cooling can assist with very rapid cooling as well.

There are several styles of thermodes in common use. These thermodes differ mainly by the shape of the tip and the direction of current flow relative to the item to be heated. FIG. 1 illustrates exemplary thermode tip types. FIG. 1A shows a roll up style tip 10, which is a U shaped foil, attached to two shanks 11. In this case, the working surface is a flat surface of the foil. FIG. 1B shows a blade style tip 12 where the foil is mounted on edge and the working surface is the bottom edge. FIG. 1C shows a peg style tip 14, which is similar to the roll up style thermode but with a protrusion 15 at the tip providing the working surface.

A thermode typically includes the following elements:
Terminals: electrical contacts where power is applied.
Mount: body of the thermode for connecting the thermode to other structures (the mount also typically includes the terminals), supports the shank.
Shank: supports the tip and conducts current to it placed between the mount and tip.
Tip: high resistance element where the majority of heat is developed.
Transition zone: area where the tip is joined to the shank.
Working surface: the portion of the tip that comes in contact with the item to be heated.
Thermocouple: a device for determining working temperature, typically attached to the tip.
Thermocouple connector: connects the thermocouple to an electrical circuit for conveying temperature data.

Important factors for a good heating process include sufficient pressure and good planarity of the thermode with the item to be heated. These factors ensure good and consistent thermal transfer and accurate temperature control. When soldering plated leads or ribbon wire, planarity is preferably better than half the thickness of the solder plate.

Thermodes are typically produced by welding a tip to a copper shank. This welded construction can result in a number of deficiencies, such as: variations in fit-up and weld penetration lead to variable device resistance with poorer welds resulting in unwanted heating; poor fit-up resulting in residual stress in the tip leading to premature failure due to stress cracking; poor fit-up resulting in poor planarity of the working surface relative to the mounting features; elements made of difficult to weld material are stressed, develop a large heat-affected zone and/or have incomplete welds which leads to unwanted hot-spots and premature failure due to stress cracks near the weld; and/or the welding process itself plus the addition of features to facilitate assembly adds extra machining steps as well as an additional process step.

Further, in the common fold up configuration, if the tip is connected to L-shaped conductors, this can result in a diagonal current flow through the tip and a diagonally distributed hot spot across the working surface of the tip, which can result in uneven heating.

Still further, mounting in known thermodes is generally complex. The thermode must typically be constrained by three datum surfaces in order to achieve controlled planarity between the working surface and the item to be heated.

Thermode lifetime is also limited by a host of mechanisms including: metal fatigue from repetitive thermal and mechanical stress; liquid metal embrittlement; liquid metal corrosion; galvanic corrosion; thermocouple detachment—particularly with tip material which is difficult to weld such as titanium; and thermocouple wire breakage from handling, thermal embrittlement, flux corrosion and other factors.

Although some suppliers have developed single-piece fold up and blade thermodes in order to eliminate welded construction, these designs typically have complex clamping arrangements and involve removable fasteners and other parts. These arrangements also typically involve the tip being subject to stress and strain, which potentially shortens the lifetime of the tip.

As such, there is a need for an improved thermode that is intended to overcome at least some of the issues in conventional thermodes.

### SUMMARY

According to an aspect herein, there is provided a thermode comprising: a shank; a tip; and a transition zone between the shank and the tip, the transition zone configured to provide resistance gradients to improve containment of heat in the tip.

In a particular case, the shank and tip are formed as a single piece. The formation of the shank and tip may be formed by, for example, wire EDM.

In another particular case, the transition zone is configured to provide resistance gradients to improve containment of heat in the tip by having a greater thickness at the shank that the thickness at the tip.

In another particular case, the thermode may further comprise a cooling jet integrated within the shank such that the cooling jet directs cooling airflow to the tip. In this case, the thermode may also include a cooling connector connected with the cooling jet in the shank, the cooling jet connector configured to connect with a matching connector on a thermode clamping system,

In yet another case, the thermode may further include a mount adjoining to and extending from the shank, wherein the mount has a greater width than the shank.

In yet another case, a galvanic lead may be provided to the tip to electrically bias the tip. This biasing of the tip is intended to reduce corrosion of the tip.

In still another case, the thermode may include a thermocouple attached to the tip in close proximity to a working surface. In this case, the thermocouple may include a galvanic lead to electrically bias the tip.

According to another aspect herein, there is provided a clamping arrangement for a thermode comprising: a clamp for clamping the thermode, wherein the clamp operates with a single actuator; an integrated heating connection for connecting to heating elements of the thermode; and an integrated cooling connection for connecting to cooling elements of the thermode.

In a particular case of the claiming arrangement the heating connection may include electrodes to provide electrical power connections to the thermode and the cooling connection may include a central pneumatic manifold arranged to separate the electrodes and provide pneumatic connections to the thermode, and the clamping arrangement may further include a support structure to hold the electrodes and the central pneumatic manifold.

In this particular case, the clamp may include one fixed jaw and a moveable jaw and the movable jaw may be configured to move by operation of the single actuator. In this case, the support structure may include datum surfaces adapted to maintain alignment of a tip of the thermode with the clamping arrangement for accurate positioning of the tip on a working surface. In particular, the fixed jaw and the moveable jaw may include a rounded point contact to establish compression of the thermode to the datum surfaces.

According to another aspect herein, there is provided a method for manufacturing a single piece compact thermode comprising: machining a first profile into a workpiece; machining a second profile into the workpiece and parting off an unfinished thermode having separate halves or terminals and shank; bonding the two halves of the terminals and shank together; and attaching a thermocouple,

In a particular case, the method may include plating the thermode. In this case the plating the thermode may include plating the shank with a conductive material, plating the tip with a protective material, or the like.

In another particular case, the method may including providing and retaining a keeper bar to facilitate handling and to maintain mechanical stability during the process.

In another particular case, the attaching the thermocouple may include swaging the thermocouple to a tip of the thermode.

Other aspects and features will become apparent to those ordinarily skilled in the art upon review of the following description of specific embodiments in conjunction with the accompanying figures.

### BRIEF DESCRIPTION OF DRAWINGS

Embodiments will now be described, by way of example only, with reference to the attached Figures, wherein:

FIG. 1 illustrates exemplary thermode tip types.

FIG. 2 illustrates a front view of a thermode according to an embodiment herein.

FIG. 3 illustrates a side view of the thermode of FIG. 2.

FIG. 4 illustrates a front view of a thermode according to another embodiment herein.

FIG. 5 illustrates a side view of the thermode of FIG. 4.

FIG. 6 illustrates a front view of a thermode according to another embodiment herein.

FIG. 7 illustrates a side view of the thermode of FIG. 6.

FIG. 8 is a flowchart illustrating a method of manufacturing a thermode according to an embodiment herein.

FIG. 9 illustrates a front view of a clamping arrangement for a thermode according to an embodiment herein.

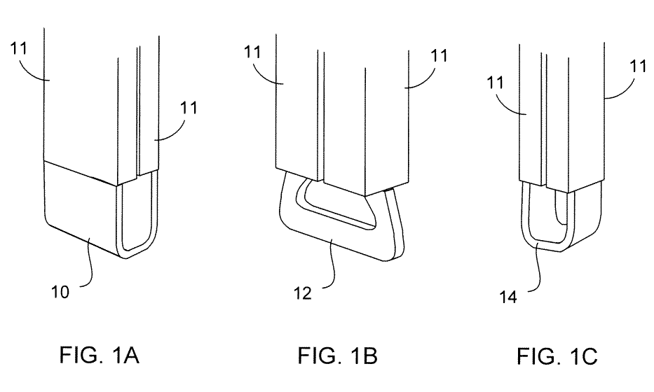

### DETAILED DESCRIPTION

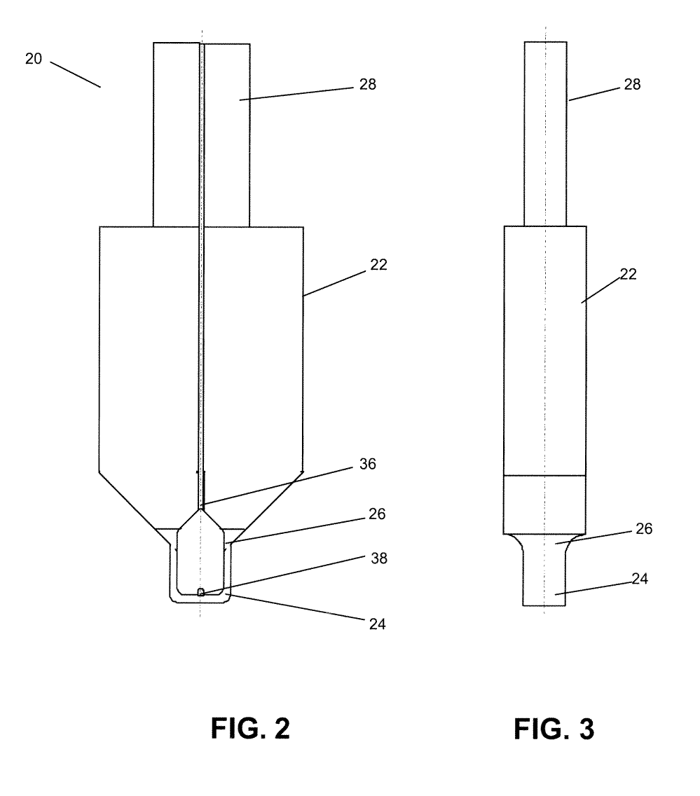

FIG. 2 illustrates a front view of a modified fold-up style plug-compatible single piece thermode (20) according to an embodiment herein. FIG. 3 illustrates a side view thereof.

The thermode (20) includes: a shank (22); a tip (24); a transition zone (26), which joins the shank (22) and the tip (24); and a mount (28), which supports the shank (22). As shown in FIGS. 2 and 3, the mount (28) adjoins and extends from the shank (22) and is formed together with the shank (22) but in a shape that can be easily mounted in another structure. The transition zone (26) is configured to have a shape to manage temperature and resistance gradients to improve containment of heat in the tip (24). In particular, the transition zone (26) is the same thickness as the tip material but expands gradually to a greater thickness at the point where the transition zone (26) meets the shank (22). An integrated cooling jet (36) may be arranged to direct cooling airflow at the tip (24). Further, a thermocouple (38) may be provided to provide temperature feedback.

The thermode (20) of FIGS. 2 and 3 is preferably formed from a single piece of material. This improves reproducibility in form and function and improves reliability by avoiding welded construction. This also improves dimensions and tolerances by machining critical features in a single setup with one tool to high precision. In some cases, the machining can be done in a single setup with one tool using, for example, EDM machining.

In this embodiment, the thermode also includes a gradient transition zone. The applicants herein have identified that known thermode designs typically incorporate an abrupt transition between the tip and the shank. This abrupt transition may be the most appropriate for welding purposes but it has been determined that an abrupt transition compromises the ability to optimize current distribution and thermal management. In this situation, poor thermal management allows heat to be stored in the shank of the thermode resulting in some process drift in high duty-cycle repetitive operation. The use of a single piece construction allows for the creation of an appropriately contoured transisition zone.

This embodiment also includes an integrated cooling jet, intended to allow for faster cooling of the tip.

This embodiment is also intended to be plug compatible with various commercially available thermode tip assemblies, which are composed of a tip welded to a two piece shank. In a particular case, the mount is composed of two ⅛″ square electrodes separated by a 1/64″ insulator which are at least ½″ long resulting in a 3.18×7.0×12.7 mm mount which is clamped to fixture the thermode and conduct heating current. This single-piece design is intended to provide compatibility with tooling common to the industry. This tooling can include existing tooling or, in some cases, a similar but non-standard electrode arrangement.

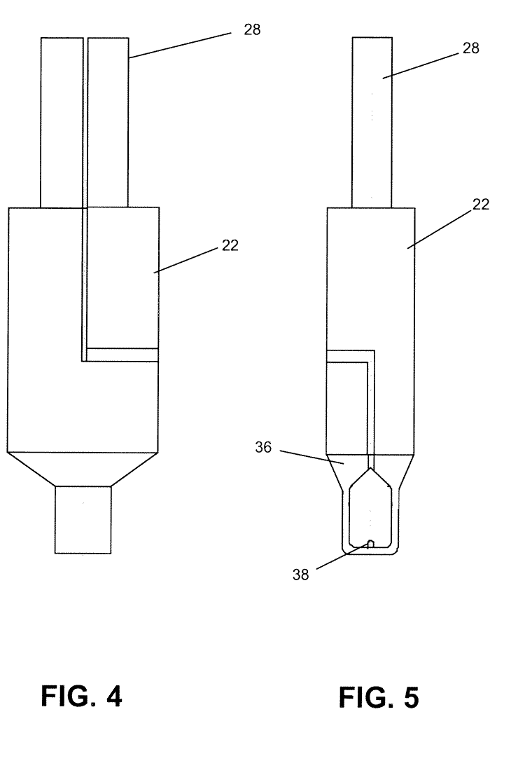

It will be understood that the single-piece construction and other elements above can be applied to the construction of fold up, blade and peg styles of thermodes. The fold up style above may sometimes be referred to as “modified fold up” because the tip is at right angles to the conventional orientation. A single piece thermode embodiment intended to be equivalent to the conventional roll-up style can be produced in a similar fashion but may require some additional machining (see FIGS. 4 and 5 and description below). However, this approach may be less preferred as current flow may be less evenly distributed.

FIG. 4 illustrates a front view of a conventional roll-up style plug compatible single piece thermode according to an embodiment herein, and FIG. 5 illustrates a side view thereof. Reference is made to the description above relating to FIGS. 2 and 3 with respect to like features. As shown in FIGS. 4 and 5, in this embodiment the air jet location is altered and may require additional machining of the shank 22 to provide the necessary pathway for the airflow.

Analysis of conventional thermodes has also revealed that thermocouple leads are generally poorly supported. Typically, thermocouples are attached directly to the thermode tip, which can result in the thermocouple circuit experiencing common mode voltages conducted to it by the tip, which, in some cases, leads to inaccurate temperature readings. This is particularly relevant when soldering solar modules, which produce voltages when exposed to stray light.

In the present embodiments, a thermocouple is attached to the tip of the thermode. Preferred locations are inside the tip typically at the mid-point (as shown in FIG. 2) or on the outside in close proximity to the working surface. Thermocouples may be attached by spot welding with the possible inclusion of a transition metal (e.g. a metal foil disc or thin metal film disc) to improve matching of metallurgical properties and/or thermal coefficients of expansion of the thermocouple materials relative to the tip material. Thermocouples may be attached by swaging into a machined receptacle. Swaging may be a preferred method of attachment when a sufficiently reliable weld cannot be formed or when electrical isolation between the thermocouple and the tip is desirable. For example, when thermodes are made from metals, which are difficult to weld to the tip material or with (mineral) insulated thermocouples. Swaged thermocouples may further be coated with a thermal transfer compound to improve retention and/or precision of temperature measurement. Typical thermocouple types are E, J or K: type J is commonly used but type K is preferred if exposure to acidic flux is likely.

In some embodiments, a galvanic protection wire (not shown) may also be attached to the tip, for example, by spot welding or swaging. This galvanic protection wire may alternatively be incorporated into the thermocouple, for example, if it is a three-wire type (e.g. jacketed or shielded). This galvanic protection wire may be used to apply an electrical bias to the tip, which can be used to control and minimize corrosive action between the tip material and the material with which the tip is in direct contact. A reduction in corrosive action can improve the life of the thermode.

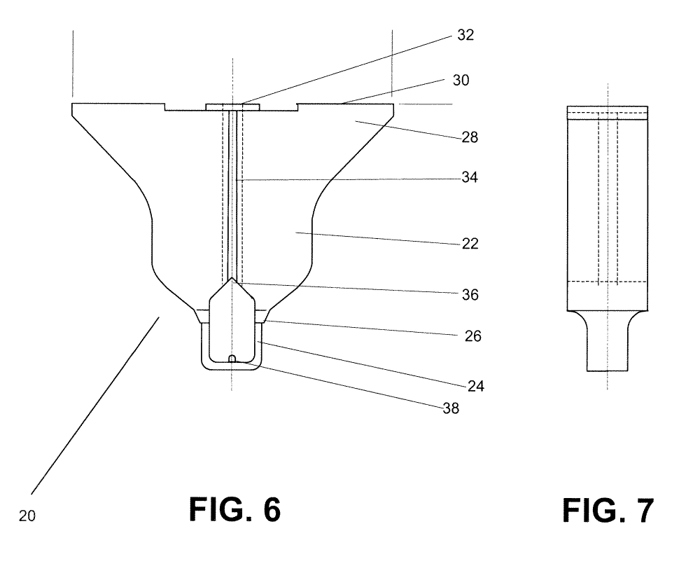

FIG. 6 illustrates a front view of a modified fold-up style compact single piece thermode (20) according to an embodiment, and FIG. 7 illustrates a side view thereof. In this embodiment, the thermode (20) is generally not plug-compatible with commercially available thermodes but is designed to be more compact and to provide an improved mounting arrangement, as described in further detail herein.

As shown in FIG. 6, the compact thermode (20) includes a shank (22), a tip (24), a transition zone (26), and a mount (28). The mount (28) adjoins and extends from the shank (22), the mount (28) having a greater width than the shank (22). The transition zone (26) joins the shank (22) and the tip (24), and has a geometric shape arranged to manage temperature and resistance gradients to improve containment of heat in the tip (24). An integrated cooling jet (36) is arranged to direct cooling airflow at the tip. A pneumatic connector (32) may be arranged to supply air to the integrated cooling jet (36).

The shank (22), tip (24), transition zone (26) and integrated cooling jet (36) can be provided in a single piece. The mount (28) can have a wider width at a terminal end thereof than at a shank adjoining end thereof. The width of the mount (28) can increase from the shank adjoining end to the terminal end. In this case, the shank (22) and the mount (28) are actually provided as an integral shank-mount.

A terminal (30) is provided at the terminal end of the mount (28). The pneumatic connector (32) is also provided at the terminal end of the mount (28). The pneumatic connector (32) is configured as a pneumatic port with a seal.

This type of thermode is designed to use an improved clamping arrangement (described in further detail below), which may incorporate both heating (electrical) and cooling (pneumatic) connections; and may use a single fastener/actuator to facilitate ease of replacement and minimize downtime. The clamp is intended to provide an increased surface area as compared to conventional designs. The clamp is also intended to provide improved electrical conductivity, improved thermal management and an improved mechanical datum. The clamp provides a planar datum, which is intended to help ensure that planarity between the thermode tip and the item to be heated is maintained. In this embodiment, the planarity is controlled by a single surface while in conventional thermodes three surfaces must typically be aligned to provide planarity.

The compact thermode design of FIGS. 6 and 7 is also intended to represent a further improvement over the single piece thermode design of FIGS. 2 and 3. In particular, the compact aspect ratio can significantly reduce the issues of distributed resistance heating and heat storage in the thermode shank. This also reduces the amount of material needed to produce a thermode, providing a cost reduction. The contact area is increased, thus reducing contact resistance and improving thermal transfer into the contacts, which also serve as sinks for excess heat. Conventional thermodes provide a contact area with dimensions of approximately 3.18 mm×12.7 mm and a fixed contact area of approximately 40 mm̂2 while the embodiments herein are intended to provide a minimum contact area of 6 mm×12 mm or an area of 72 mm̂2 but which can be increased for larger thermodes. These thermodes are mounted by means of a clamp, and as such do not require loose fasteners or other hardware. A single, non-removable fastener or actuator can be used to clamp the thermode in place facilitating rapid replacement.

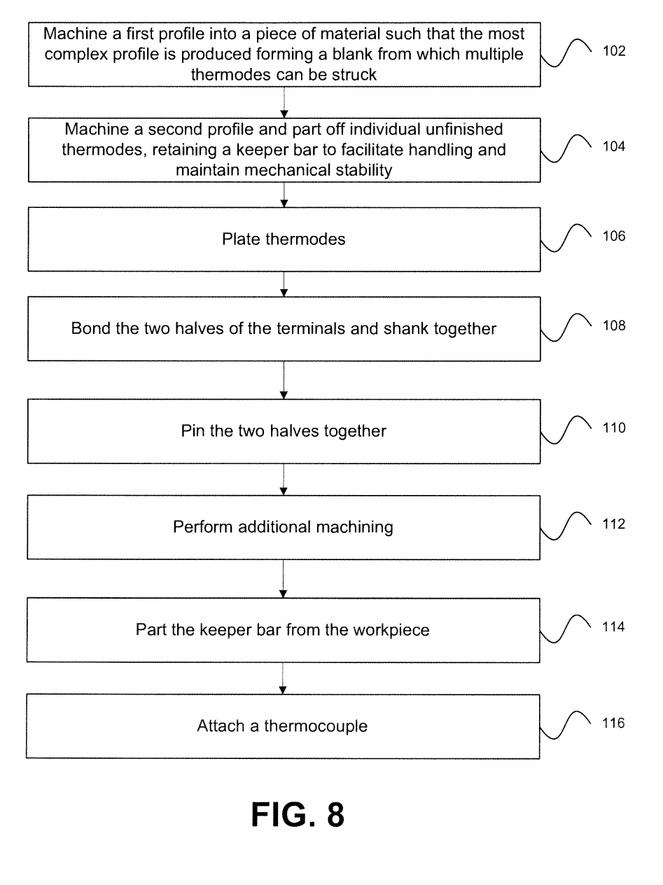

FIG. 8 is a flowchart illustrating an example embodiment of a method of manufacturing a single piece thermode.

In this embodiment, the thermode is produced by machining a single piece of metal. Preferred metals combine moderate resistivity, good mechanical strength and good corrosion resistance. Presently preferred metals include: low resistance grades of Titanium such as commercially pure Ti in ASTM grades 1, 2, 3 or 4; alloys of Ti with moderate resistivity such as ASTM grades 12, 15, 17 or 9; other alloys of titanium may be used, particularly for thermodes with relatively small tips; stainless steels particularly those alloys with no or negligible nickel content and relatively high carbon and phosphorous content such as stainless 416, 420 or 430; and other commonly used metals such as inconel and tungsten steel.

At 102, a first profile (typically the most complex profile) is machined into a piece of material (workpiece) to form the initial thermode shape. The machining may be conducted, for example, by a wire electrical discharge machining (EDM) tool. In practice, the method may actually be performed such that a plurality of thermodes may be machined at this stage, In particular, the first profile may be formed on a blank from which multiple thermodes can be struck—for example, as many as can be accommodated within the envelope of a wire EDM tool.

In a particular case, the manufacturing sequence may preferably incorporate the use of a keeper bar. The keeper bar is used to: hold and fixture the workpiece during manufacture to improve fixturing and prevent tool marks; hold critical dimensions until all manufacturing operations are complete; and, in some cases, hold multiple workpieces in a grouping so that several/many thermodes can be machined at one time with one setup to minimize manufacturing costs. The keeper bar is preferably attached to the main body of the workpiece in such a way that the contact areas which also serve as a datum for locating the thermode when in use can be formed in the same machining operation as the tip, in order to ensure the best parallelism between these surfaces.

At 104, a second profile is machined on the workpiece to complete the thermode shape. In the case where multiple thermodes are machined at the same time, individual unfinished thermodes may also be parted off. In either case, it is preferred to retain a keeper bar to facilitate handling and help maintain mechanical stability.

At 106 (optional), the workpieces may be plated. For example, tips or tips and shank may be plated with a protective material. In another example, terminals or terminals and shank may be plated with a conductive material.

Plating may be applied to various parts, for example: a highly conductive non-oxidizing metal to reduce contact resistance in the electrode clamping area such as gold plate; a protective barrier for increased corrosion resistance and/or reduced solder wetting of the tip such as TiN, DLC, etc; the tip may also be protected by a barrier layer formed through heating or self heating which causes a reaction with an atmosphere with the resulting layer being composed of an oxide or nitride of one or more components of the base metal.

At 108, the two halves of the terminals and shank are bonded together, for example, using a high temperature epoxy or other suitable method. At 110, another optional element, the two halves may also be pinned together for additional strength.

At 112, also optional, additional machining may be performed, such as: to provide cooling jet air passages; to prepare the tip for thermocouple attachment or strain relief; and/or to mark the part with part numbers or serialization information.

At 114, the keeper bar is parted from the work-piece.

A thermocouple is attached at 116. For example, the thermocouple can be spot-welded or swaged to the tip. Leads for the thermocouple can be strain-relieved by attachment to the shank with means such as high temperature tape, spot welded metal tab or bolt-on wire clamp. Leads for the thermocouple can be trimmed to length and a connector can be attached. As noted above, a galvanic protection lead can be attached separately from or together with the thermocouple.

As noted with regard to FIGS. 6 and 7, a cooling fitting may be attached to allow for easy connection to a cooling supply, such as, for example, pneumatic air cooling or the like.

It will be understood that some of the method elements may be optional or varied and that some method elements may be performed in a different order than that listed depending on various factors such as the quantity of thermodes to be produced and the like.

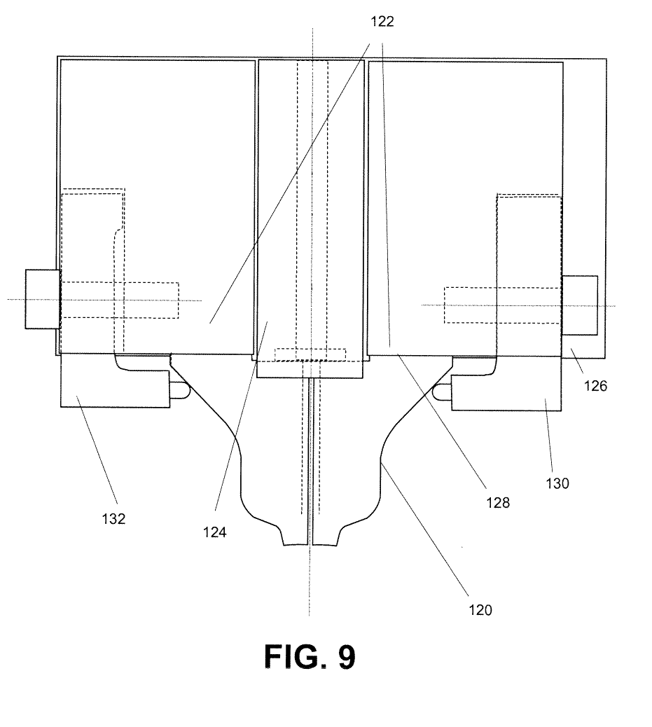

FIG. 9 illustrates a front view of an example clamping arrangement for a thermode such as that shown in FIGS. 6 and 7.

As shown in FIG. 9, this type of thermode (12) uses a clamping arrangement which: incorporates both heating (electrical) and cooling (pneumatic) connections; and uses a single fastener/actuator to facilitate ease of replacement and minimize downtime.

In the embodiment shown, the clamp assembly or system comprises the following elements:
i) Electrodes (122): two electrodes can be provided. The electrodes can be copper or another highly conductive metal, possibly with gold plated contact surfaces to prevent oxidation. The electrodes provide electrical power connections to the thermode. The surface of these elements can also provide a radiator, which dissipates excess heat rapidly for improved process stability.
ii) A central pneumatic manifold (124) to separate the electrodes (122) and provide pneumatic connections to the thermode, as well as providing some guidance to keep the thermode aligned in the transverse direction and with respect to rotation.
iii) A supporting structure (126) to hold the elements of the clamping arrangement and maintain alignment by means of datum surfaces (128). The datum surfaces (128) are intended to provide planarity between the thermode tip and the item to be heated when the thermode is clamped.
iv) Two jaws: one fixed jaw (130) and one movable jaw (132) to permit replacement of thermodes. Each may be provided with, for example, a rounded point contact to establish compression of the thermode to the clamp datum with stability by establishing a compression force, which is substantially centered over the datum contact area.

In this embodiment, the clamp provides an increased surface area as compared to conventional designs to provide improved electrical conductivity and thermal management. Conventional thermodes provide a contact area with dimensions of approximately 3.18 mm×12.7 mm and a fixed contact area of approximately 40 mm̂2 while embodiments herein are intended to provide a contact area of 6 mm×12 mm or an area of 72 mm̂2 but which can be increased for larger thermodes.

The clamp also provides a planar datum, which is intended to help ensure that planarity between the thermode tip and the item to be heated is maintained.

A mounting arrangement such as that shown in FIG. 9 is intended to provide one or more of the following features: improve the achievable planarity of the tip to the item to be heated by reducing the number of critical surfaces and related machining tolerances; simplify change-out and reduce replacement time; simplify air cooling connections. Integrated cooling jets also improve the reproducibility of cooling cycles from thermode to thermode; and increase electrical terminal contact area.

Generally speaking, embodiments herein are intended to comprise one or more of the following elements or features:
One piece design: to reduce stress caused by welding tip to shank.
A transition zone (26): a portion of the thermode joining the shank and tip where temperature and resistance gradients are managed by geometric shape designed to improve containment of heat in the tip. As described above, conventional designs typically incorporate an abrupt transition where the tip is welded or clamped to the shank. In a single-piece design according to an embodiment herein, this transition zone or region can be provided as a flare or other geometric form in which thermal and resistance gradients vary in such a way as to contain the majority of resistance heating in the tip itself while minimizing the amount of heat conducted from the tip into the shank.
Integrated cooling jet (36): an integrated element, which directs cooling airflow at the tip.
Pneumatic connector (32): means of supplying air to a cooling jet.
Bonding lead (galvanic protection wire): optional means of electrically referencing the tip to provide galvanic or electrical protection.

It will be understood that, for the compact thermode and clamping arrangement described herein, it may be possible to provide a kit including a clamping arrangement for the compact thermode that allows a conventional thermode device to be converted for use of the clamping arrangement and compact thermode described herein.

Embodiments described herein are also intended to provide advantages over existing approaches, which may include: minimize part count; simplified manufacturing process; lower cost; improve reliability; and improved serviceability with rapid replacement.

In the preceding description, for purposes of explanation, numerous details are set forth in order to provide a thorough understanding of the embodiments described herein. However, it will be apparent to one skilled in the art that these specific details are not required in order to practice these embodiments.

The above-described embodiments are intended to be examples only. Alterations, modifications and variations can be effected to the particular embodiments by those of skill in the art without departing from the scope of the application.

We claim:

1. A thermode comprising:
a shank;
a tip; and
a transition zone between the shank and the tip, the transition zone configured to provide resistance gradients to improve containment of heat in the tip.

2. The thermode of claim 1, wherein the shank and tip are formed as a single piece.

3. The thermode of claim 1, wherein the transition zone is configured to provide resistance gradients to improve containment of heat in the tip by having a greater thickness at the shank that the thickness at the tip.

4. The thermode of claim 1, further comprising a cooling jet integrated within the shank, the cooling jet configured to direct cooling airflow to the tip.

5. The thermode of claim 4, further comprising a cooling connector connected with the cooling jet in the shank, the cooling jet connector configured to connect with a matching connector on a thermode clamping system.

6. The thermode of claim 1, further comprising a mount adjoining to and extending from the shank, wherein the mount has a greater width than the shank.

7. The thermode of claim 1, wherein a galvanic lead is provided to the tip to electrically bias the tip.

8. The thermode of claim 1, further comprising a thermocouple attached to the tip in close proximity to a working surface.

9. The thermode of claim 8, wherein the thermocouple comprises a galvanic lead to electrically bias the tip.

10. A clamping arrangement for a thermode comprising:
a clamp for clamping the thermode, wherein the clamp operates with a single actuator;
an integrated heating connection for connecting to heating elements of the thermode; and
an integrated cooling connection for connecting to cooling elements of the thermode.

11. The clamping arrangement of claim 10, wherein
the heating connection comprises electrodes to provide electrical power connections to the thermode;
the cooling connection comprises a central pneumatic manifold arranged to separate the electrodes and provide pneumatic connections to the thermode; and
the clamping arrangement further comprises:
a support structure to hold the electrodes and the central pneumatic manifold.

12. The clamping arrangement of claim 11, wherein the clamp comprises one fixed jaw and a moveable jaw and the movable jaw is configured to move by operation of the single actuator.

13. The clamping arrangement of claim 12 wherein the support structure comprises datum surfaces adapted to maintain alignment of a tip of the thermode with the clamping arrangement for accurate positioning of the tip on a working surface.

14. The clamping arrangement of claim 13 wherein the fixed jaw and the moveable jaw comprise a rounded point contact to establish compression of the thermode to the datum surfaces.

15. A method for manufacturing a single piece compact thermode comprising:
machining a first profile into a workpiece;
machining a second profile into the workpiece and parting off an unfinished thermode having separate halves or terminals and shank;
bonding the two halves of the terminals and shank together; and
attaching a thermocouple.

16. The method of manufacturing of claim 15, wherein the method further comprises plating the thermode.

17. The method of manufacturing of claim 16, wherein plating the thermode comprises plating the shank with a conductive material.

18. The method of manufacturing of claim 15, wherein the method further comprises providing and retaining a keeper bar to facilitate handling and to maintain mechanical stability.

19. The method of manufacturing of claim 15, wherein attaching the thermocouple comprises swaging the thermocouple to a tip of the thermode.
